(19) United States
(12) Patent Application Publication
(10) Pub. No.: US 2022/0245240 A1
(43) Pub. Date: Aug. 4, 2022

(54) SYSTEM, METHOD, AND PROCESS FOR IDENTIFYING AND PROTECTING AGAINST ADVANCED ATTACKS BASED ON CODE, BINARY AND CONTRIBUTORS BEHAVIOR

(71) Applicant: APIIRO LTD., Tel Aviv (IL)

(72) Inventors: Idan Plotnik, Herzliya (IL); Yonatan Eldar, Tel Aviv (IL); Eli Shalom, Tel Aviv-Yafo (IL); Ariel Levy, Haifa (IL)

(21) Appl. No.: 17/589,935

(22) Filed: Feb. 1, 2022

Related U.S. Application Data
(60) Provisional application No. 63/143,993, filed on Feb. 1, 2021.

(51) Int. Cl. G06F 21/54; G06F 21/55; G06F 21/56; G06K 9/62; G06N 20/00

(52) U.S. Cl. CPC G06F 21/54; G06F 21/554; G06N 20/00; G06K 9/6256; G06F 21/563

(57) ABSTRACT

A method for detecting undesired activity prior to performing a code build, the method including: (a) learning behaviors of each of a plurality of entities so as to train unique models for each of the plurality of entities; (b) monitoring new events of the plurality of entities to detect anomalous behavior relative to corresponding models of the unique models; and (c) executing a workflow for remediation of a detected anomalous behavior. A method for monitoring and protecting a deployment process post build, the method including: receiving source code and a corresponding binary resulting from the build of the source code; comparing the source code to the binary for at least one discrepancy there-between; and halting the deployment process if the at least one discrepancy is detected.

This patent application claims the benefit of U.S. Provisional Patent Application No. 63/143,993, filed Feb. 1, 2021, which is incorporated in its entirety as if fully set forth herein.

### FIELD OF THE INVENTION

This invention relates to detection and protection of attacks on applications, infrastructure or open source code during development or build phases.

### BACKGROUND OF THE INVENTION

Attacks on application, infrastructure and open source code may compromise it's functionality in a way that makes the receiver of the artifacts vulnerable. These attacks are of high risk since classical methods of defense ensure that the artifacts have not been changed after release, but may skip malicious code detection in the artifacts. Such abnormal/malicious code may be added to the software in various ways. The addition might be performed directly into the source code, by a legitimate developer, a hijacked identity of developer, or an unknown identity. The addition might be performed during the build phase, where the built binaries might include malicious code added or weaved into the binaries. Additional attacks might be on interpreted code being manipulated in a similar manner during a pre-deployment phase.

### SUMMARY OF THE INVENTION

According to the present invention there is provided a method for detecting undesired activity prior to performing a code build, the method including: (a) learning behaviors of each of a plurality of entities so as to train unique models for each of the plurality of entities; (b) monitoring new events of the plurality of entities to detect anomalous behavior relative to corresponding models of the unique models; and (c) executing a workflow for remediation of a detected anomalous behavior.

According to further features the behaviors are learned from historical data and on-going data. According to further features the historical data provides a respective baseline behavior for each of the plurality of entities, during a learning phase. According to further features each of the unique models is updated using the on-going data, during an operational phase.

According to further features the unique models are machine learning (ML) models. According to further features the learning phase includes: collecting and extracting a set of calculated features for each entity of the plurality of entities. According to further features each entity is selected from the group including: a code contributor, a team of contributors, a repository, an application, a business unit, and an organization.

According to further features one of the new events that deviates from a corresponding unique model of the unique models is assigned a deviation score; and if the deviation score is above a threshold then the one new event is determined to be the detected anomalous behavior.

According to another embodiment there is provided a method for monitoring and protecting a deployment process post build, the method including: receiving source code and a corresponding binary resulting from the build of the source code; comparing the source code to the binary for at least one discrepancy there-between; and halting the deployment process if the at least one discrepancy is detected.

According to further features the source code is compared to the binary by a mapping function configured to output a mapping of the source code and the binary; and examining the mapping for the at least one discrepancy.

According to further features the mapping function includes: mapping of the source code to output structural symbols; parsing the binary to extract and map out binary symbols; and detecting additions or omissions between the structural symbols and the binary symbols.

According to further features the method further includes incorporating compiler behavior mimicking in the mapping function. According to further features the method further includes training a machine learning (ML) model on examples of compiler translations and incorporating the ML model in the mapping function.

According to further features when the binary has been manipulated to include implicit functionality, the mapping function performs pattern recognition to detect patterns relating to the implicit functionality.

According to further features when a code obfuscation step has been employed in a build process of the binary, the mapping function is assembled by using obfuscation mapping. According to further features the mapping further includes reverse engineering compilation optimizations.

According to further features the mapping function further includes: mapping executable sections of the source code and the binary, and at least one of: mapping external references, comparing listed terminals, and comparing an order of internal symbols.

According to further features the binary has been manipulated to include implicit functionality, the mapping function performs pattern recognition to detect patterns relating to the implicit functionality.

According to further features the method further includes a step of verifying reference symbols.

According to another embodiment there is provided a method for protecting a software deployment process, the method including: prior to a code build: learning behaviors of each of a plurality of entities so as to train unique models for each of the plurality of entities; monitoring new events of the plurality of entities to detect anomalous behavior relative to corresponding models of the unique models; executing a workflow for remediation of a detected anomalous behavior; after the code build: receiving source code and a corresponding binary resulting from the code build of the source code; comparing the source code to the binary for at least one discrepancy there-between; and halting the deployment process if at least one discrepancy is detected.

### BRIEF DESCRIPTION OF THE DRAWINGS

Various embodiments are herein described, by way of example only, with reference to the accompanying drawings, wherein:

FIG. 1 is a flow diagram 100 of the pre-build methodology;

FIG. 2 is a flow diagram 200 of a method monitoring and protecting a deployment process after a build of the source into a binary.

### DESCRIPTION OF THE PREFERRED EMBODIMENTS

There are disclosed herein two main methods, pre-build and post-build, for detection and protection against attacks on code.

The pre-build method observes the contributors, repositories, peers, and other behavioral features to detect abnormal contributions and trigger remediation actions. The detection is built on an iterative learning phase, followed by a detection phase.

The post-build method observes source code snapshots and resulting binaries. The detection is built on predefined adaptive rules and learnable rules, which allow creating an extensive mapping between the source code and the binary. Discrepancies in the mapping indicate on code attacks and their location in the code.

Overview

Pre-build—the system integrates with the development environment in its extended form, e.g., source control, ticketing system, messaging system. Given an integration, the system receives both historical and on-going data. A periodic learning phase is performed to create criteria for abnormality detection and scoring. Additionally, on every event that requires evaluation, such as code commit, an analysis that uses the results from the learning phase is performed. According to the analysis an abnormality classification is assigned to the event, and a corresponding workflow can be executed.

Post-build—given the same integration as the pre-build phase, along with build system integration, on every/selected build/s a discrepancy detection is performed. The detection can be triggered as an embedded phase in the build system or as an external service. The detection is performed using analysis of mappings between the source code and the binaries, accompanied by external resources verifications.

The principles and operation of a method and system for detection of, and protection from, attacks on applications, infrastructure and/or open-source code during development and/or build phases according to the present invention may be better understood with reference to the drawings and the accompanying description.

Pre-Build Flow

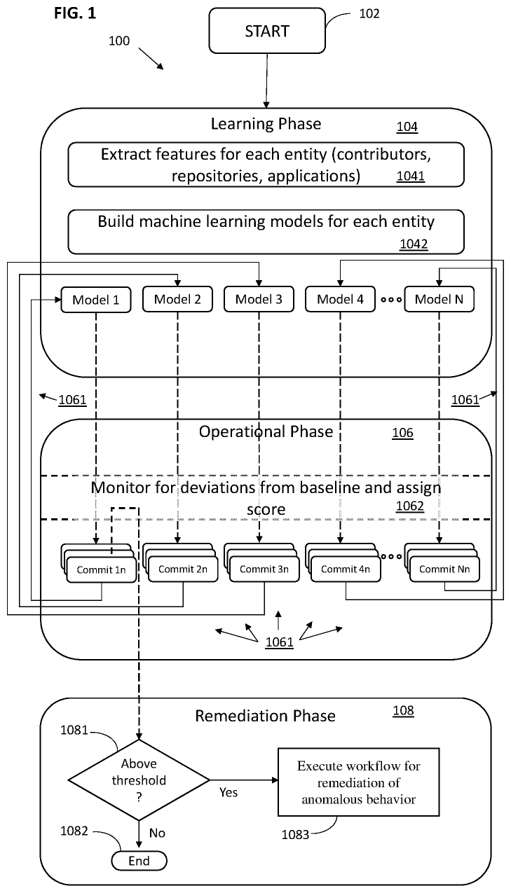

Referring now to the drawings, FIG. 1 illustrates a flow diagram 100 of the pre-build methodology. The method starts at step 102 which may be an installation and/or calibration of the instant system with the host system.

Detecting Anomalous Contributor Behavior

The system uses the personal history of code-commits of contributors (developers, architects, ‘devops’, quality assurance (QA), product managers, etc.) to code repositories to detect anomalous behavior and events.

Step 104 is the Leaning Phase. In the learning phase, at sub-step 1041, the system collects and extracts a set of calculated features for each repository/application and each contributor. These features represent the corresponding behavioral characteristic of each entity (repository/user).

In sub-step 1042, the extracted features are used to build per-repository/application and per-contributor machine learning models (model 1-model N). Once the models are established, they are used as a baseline for the operational phase to detect deviations from the learnt behavior and to assign an anomaly/risk score to each commit.

In addition, for each contributor and each repository/application (hereafter also generally referred to as “entity”) the system calculates their corresponding peer-groups. Calculating the peer groups is useful, for example, for: bootstrapping models and eliminating false detection.

Bootstrapping models enables anomaly detection from day zero by inheriting the peer group behavior even before establishing the entity model for the new entity. Eliminating false detection is achieved by comparing the behavior of the entity to its peer group and taking into account global events across the peer group.

Some examples of the extracted features that are used to build the models include, but are not limited to:

Repository/application model features:
Number of days in learning period
Number of active days, with at least one commit
Number of commits during the training period
Number of committers that committed to the repository during the learning period
Number of days elapsed from the last commit
Day of week
   Number of commits to the repository in each day of week
   Percentages of commits to the repository in each day of week (histogram)
   Entropy of days of week histogram
Hours of day
   Number of commits to the repository in each hour of day
   Percentages of commits to the repository in each hour of day (histogram)
   Entropy of hours of day histogram
Material changes (MC)—a related discussion of this topic is disclosed in a co-pending U.S. patent application Ser. No. 16/884,116 of the same inventors, filed May 27, 2020, which is entitled “System, Method And Process For Continuously Identifying Material Changes And Calculating Risk for Applications and Infrastructure” is incorporated in its entirety as if fully set forth herein.
   Number of MCs during the learning period
   Percentages of each MC
   Entropy of MCs
   Risk score of MCs
Commit files
   Number of files committed during the learning period
   Percentages of each commit file
   Entropy of commit files
   File sensitivity
   Risk score of commit files
Peer-group of repositories
   Contributor model features:
Number of days in learning period
Number of active days, with at least one commit
Number of commits during the training period
Number of repositories that the user committed to during the learning period
Number of days elapsed from the last commit
Day of week
   Number of commits to any repository in each day of week
   Percentages of commits to any repository in each day of week (histogram)
   Entropy of days of week histogram
Hours of day
   Number of commits to any repository in each hour of day
   Percentages of commits to any repository in each hour of day (histogram)
   Entropy of hours of day histogram
Material changes (MC)
   Number of MCs during the learning period to any repository
   Percentages of each MC
   Entropy of MCs
   Risk score of MCs
Commit files
   Number of files committed during the learning period to any repository
   Percentages of each commit file
   Entropy of commit files
   Risk score of commit files
Peer-group of users
   Contributor-repository model features (calculated for each tuple of contributor and repository):
Number of active days, with at least one commit, of the contributor in the repository
Number of commits during the training period to the repository
Number of days elapsed from the last commit to the repository
Day of week
   Number of commits to the repository in each day of week
   Percentages of commits to the repository in each day of week (histogram)
   Entropy of days of week histogram
Hours of day
   Number of commits to the repository in each hour of day
   Percentages of commits to the repository in each hour of day (histogram)
   Entropy of hours of day histogram
Material changes (MC)
   Number of MCs during the learning period to the repository
   Percentages of each MC
   Entropy of MCs
   Risk score of MCs
Commit files
   Number of files committed during the learning period to the repository
   Percentages of each commit file
   Entropy of commit files
   Risk score of commit files

The models (model 1-model N) are used to learn the behavior (also referred to as being trained on the behavior) of each contributor, each repository/application, and each contributor in each repository/application.

Step 106 is the operational phase. In the operational phase, new commits are made in sub-step 1061. In FIG. 1, each commit is labeled Commit 1₁₋ₙ, Commit 2₁₋ₙ, Commit 3₁₋ₙ, . . . Commit N₁₋ₙ. The system uses the established machine learning models (Model 1-N) to assess, in sub-step 1062, each commit and detect anomalous events. It is made clear that the code commit is merely an example of an event, but that the scope is in no way limited only to code commits, but rather includes an event for which an abnormality and/or maliciousness determination needs to be made. For example, anomalous event may occur, and be detected, with respect:
The expected behavior and characteristics of commits in the repository
The expected behavior of the committer in general
   Based on his past behavior
   Based on his peer-group behavior
The expected behavior and characteristics of the committer in the repository
   Based on his past behavior
   Based on the behavior of the other committers in the repository/application
   Based on his peer-group behavior

This way, the system integrates both global and local behavior models to evaluate each commit and assign a corresponding anomaly/risk score. Since the behavior of the users and the repositories evolves over time, the system constantly updates its models, in step 1063, to reflect the most accurate baseline.

Step 108 is a remediation phase. For every event that requires evaluation, such as a code commit, an analysis that uses the results from the learning phase is performed. According to the analysis, an abnormality classification or score is assigned to the event in sub-step 1062. In the depicted example, Commit 1n is detected as being anomalous. In the remediation phase 108, it is determined, at step 1081, whether the score is above a threshold or not. If the score is not above the threshold, the remediation process terminates at step 1082. On the other hand, if the score is determined to be above the threshold, then, at step 1083, a corresponding workflow for remediation of the anomalous behavior is executed.

Post-Build Flow

Code is susceptible to malicious manipulation at multiple stages throughout production. One of these phases is the build phase. During this phase, the code can be manipulated in many forms, such as addition, removal, replacement, weaving, etc. For example, a compromised build system could weave code before signing the binaries, making it look like a valid artifact.

The invention lays out a method for comparing a compiled binary against the source code from which it originated. In cases where there is a difference between the two, there is a danger that the build system was attacked in order to deploy malicious code through a legitimate binary.

One approach to ensuring that the compiled binary reads on the source code is to rebuild the binaries from the source code and compare the binaries. This approach may encounter two difficulties. One difficulty is the resources required to build the binaries, which can add up to many hours in some systems. The second difficulty is that if the build system has been compromised, the extent to which it is compromised is unknown and may be applied to the discrepancy detection system as well.

There is disclosed herein a new solution to the aforementioned problem. The instant solution provides an independent detection and protection process, i.e., the system is independent of the build system.

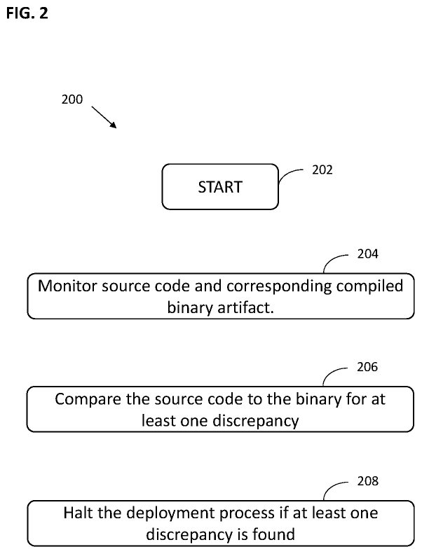

FIG. 2 illustrates a flow diagram 200 of a method monitoring and protecting a deployment process after a build of the source into a binary (hereafter “post build”). The method starts at step 202 which may represent the build itself.

At step 204 of the process, the system receives, loads and/or monitors the source code and corresponding compiled binary artifact (hereafter “binary”) resulting from the build of the source code.

At step 206 of the process, the system compares the source code to the binary for at least one discrepancy between the two. Primarily, the source code is compared to the binary by a mapping function that is configured to output a map or mapping of the source code and the binary. The system then examines or compares the two for at least one discrepancy.

If such a discrepancy is found, the system halts the deployment process at step 208. The post build detection and protection system will now be described in additional detail. The instant detection and protection system uses three main components to detect and prevent discrepancies between source code and binaries:
1. Source code to structural symbols mapping;
2. Source code to executable sections symbols mapping; and
3. Manipulation of symbols references.

Should any one of these components, individually or in combination, indicate that there is a discrepancy between a given source code and the corresponding compiled binaries, the deployment process is halted.

Solution Components

1. Source Code to Structural Symbols Mapping

An attack may include new symbols injected into the binaries. For example, a new module, a new class, a new method, or a new code construct, in which malicious code can be hosted. In this case, the detection of new structural symbols would identify an attack.

An example is shown below. In the left-hand box below is the original class. In the right-hand box is the manipulated class with an additional symbol:

AuthenticationService
-token: string
Authenticate(user, pass): bool

AuthenticationService
-token: string
Authenticate(user, pass): bool
BypassAuthentication(user, pass): bool

The source code will look like this:

```
public class AuthenticationService {
  private string token;
  public boolean Authenticate(user, pass) {
    // Authentication logic
  }
}
```

Given a parser, a syntax tree for the class can be created, and the definition nodes (e.g., class declaration or method declaration) can be extracted and mapped into the binary symbols. In the above example, the symbol BypassAuthentication will not be part of the mapping and therefore will be detected as an addition.

Given a perfect mapping, additions or omissions of symbols are detected. Any binary symbol without a source in the mapping is an addition, and any source code symbol without a target is an omission.

In summary, the mapping function includes: mapping the source code to output [a set of] structural symbols or to provide a source code symbols map. This can be done by, for example, parsing the binary to extract and map out binary symbols. The next step is to look for additions or omissions between the structural symbols (source code symbols map) and the binary symbols. Such additions or omissions are or indicate a discrepancy between the source code and the binary.

Compiler Manipulation

In some languages, a compiled source code will have a different representation in the binaries. For example, generator methods are translated into multiple symbols, or declarative getters/setters are translated into methods. In order to create a valid mapping that takes into account compiler manipulations, two methods for improving the mapping function can be used:

(1) Compiler behavior mimicking: most compilers share the rules by which constructs are translated into symbols, and those can be incorporated into the mapping function.

(2) Learnable machine translation: Since the compiler's translation is consistent, then in a safe environment, examples of source code and binaries can be generated. Those examples can be fed into a machine learning (ML) model that learns the translation. The ML model can be incorporated in the mapping function

Post-Build Steps

Some build flows include a post-build step that manipulates the binaries to include implicit functionality. For example, logging logic or error handling logic can be added to the code following declarative hints in the code. Since the added symbols correspond to declarative hints, and since the usage is widespread and ubiquitous in the code, patterns arise and allow on-the-fly learning of these patterns and incorporation of the patterns in the mapping function. For example, the mapping function performs pattern recognition to detect patterns relating to the implicit functionality that was added to the binary in the post build step.

Code Obfuscation

Some builds perform code obfuscation as a last step. Obfuscation frameworks create an artifact which is an internal symbols mapping, between the original name to the mangled name. The symbols mapping function can be assembled by using obfuscation mapping to avoid missing symbols.

Compilation Optimizations

Compilers may omit some symbols, or inline them for efficiency. Optimizations such as those can be reversed engineered and incorporated into the mapping function. An omission is mostly done for dead code, which can be detected using a call graph created by a parser Inline code can be verified using analysis of the body of functions that call the inlined function. This analysis is also enabled by the call graph.

2. Source Code to Executable Sections Symbols Mapping

An attack may include new symbols injected into executable sections of the code, such as method bodies. The mapping function of executable sections maps properties of the execution in a manner that is loosely coupled to the compiler. The mapping function maps all the external references, such as method calls, and the number of their occurrences. In a case where a new call has been weaved into the method body, a discrepancy will be detected between the source code and the binary. Additionally, terminals, such as constants, are listed along with their occurrences, and discrepancies will be detected between the source code and the binary if a new terminal was added. For example, if an argument is added to a function call, the occurrences of the terminal will change. Lastly, a partial order of the internal symbols is maintained to some extent. A difference in the order of occurrences of internal symbols will detect manipulation of the method body. An example of such manipulation can be a movement of sensitive logic from within a condition block to the main block.

Post-Build Steps

Some build flows include a post-build step that manipulates the binaries to include implicit functionality. For example, logging logic or error handling logic can be added to the code following declarative hints in the code. The new logic can be weaved into executable code blocks such as method bodies. In this case, some discrepancy is expected. Since the weaving is done using templates, and the weaving is expected to have multiple occurrences, an on-the-fly learning of the patterns can be performed. Once a pattern has been established, the mapping can take the expected translation into account.

3. Manipulation of Symbols References

An attack may include a replacement of reference symbols. An example is a replacement of a referenced library. An additional example is a replacement of a reference to a method being called from the code.

A reference replacement to a library is detected by a verification of the library signature. The signature is pulled from the library's repository.

A reference replacement to a symbol is detected by a call graph discrepancy. In case a specific method reference has been replaced, a new source-target reference is created, even if the names of the symbols are identical. The added source-target reference indicates a reference has been replaced.

A final step in the detection and protection method is to halt the deployment process when a discrepancy between source code and compiled binaries has been discovered.

In order to ensure no manipulated code is deployed, a new phase can be added to the deployment process. In most systems, the deployment process is built of multiple phases, such as build/compile, test, sign, etc., where some of the phases can stop the deployment process. For example, if the test phase fails, the deployment might be halted to avoid deploying flawed artifacts. The instant innovation includes a generic integration phase that is agnostic to the build system.

The phase is composed of a generic component receiving a snapshot of the code and the matching artifacts. The component builds mappings and verifies signatures, and accordingly reports a success/fail status, along with discrepancies if any exist. The component interface can be an in-process API, a build step embedded in the build system, or one triggered by an HTTP API.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method for detecting undesired activity prior to performing a code build, the method comprising:
(a) learning behaviors of each of a plurality of entities so as to train unique models for each of said plurality of entities;
(b) monitoring new events of said plurality of entities to detect anomalous behavior relative to corresponding models of said unique models; and
(c) executing a workflow for remediation of a detected anomalous behavior.

2. The method of claim 1, wherein said behaviors are learned from historical data and on-going data.

3. The method of claim 2, wherein said historical data provides a respective baseline behavior for each of said plurality of entities, during a learning phase.

4. The method of claim 2, wherein each of said unique models is updated using said on-going data, during an operational phase.

5. The method of claim 1, wherein said unique models are machine learning (ML) models.

6. The method of claim 3, wherein said learning phase includes:
collecting and extracting a set of calculated features for each entity of said plurality of entities.

7. The method of claim 1, wherein each entity is selected from the group including: a code contributor, a team of contributors, a repository, an application, a business unit, and an organization.

8. The method of claim 1, one of said new events that deviates from a corresponding unique model of said unique models is assigned a deviation score; and if said deviation score is above a threshold then said one new event is determined to be said detected anomalous behavior.

9. A method for monitoring and protecting a deployment process post build, the method comprising:
receiving source code and a corresponding binary resulting from the build of said source code;
comparing said source code to said binary for at least one discrepancy there-between; and
halting the deployment process if said at least one discrepancy is detected.

10. The method of claim 9, wherein said source code is compared to said binary by a mapping function configured to output a mapping of said source code and said binary; and examining said mapping for said at least one discrepancy.

11. The method of claim 10, wherein said mapping function includes:
mapping of said source code to output structural symbols;
parsing said binary to extract and map out binary symbols; and
detecting additions or omissions between said structural symbols and said binary symbols.

12. The method of claim 11, further including incorporating compiler behavior mimicking in said mapping function.

13. The method of claim 11, further including training a machine learning (ML) model on examples of compiler translations and incorporating said ML model in said mapping function.

14. The method of claim 10, wherein when said binary has been manipulated to include implicit functionality, said mapping function performs pattern recognition to detect patterns relating to said implicit functionality.

15. The method of claim 10, wherein when a code obfuscation step has been employed in a build process of said binary, said mapping function is assembled by using obfuscation mapping.

16. The method of claim 10, wherein said mapping further includes reverse engineering compilation optimizations.

17. The method of claim 10, wherein said mapping function further includes: mapping executable sections of said source code and said binary, and at least one of: mapping external references, comparing listed terminals, and comparing an order of internal symbols.

18. The method of claim 17, wherein said binary has been manipulated to include implicit functionality, said mapping function performs pattern recognition to detect patterns relating to said implicit functionality.

19. The method of claim 9, further including a step of verifying reference symbols.

20. A method for protecting a software deployment process, the method comprising:
prior to a code build:
learning behaviors of each of a plurality of entities so as to train unique models for each of said plurality of entities;
monitoring new events of said plurality of entities to detect anomalous behavior relative to corresponding models of said unique models;
executing a workflow for remediation of a detected anomalous behavior;
after said code build:
receiving source code and a corresponding binary resulting from said code build of said source code;
comparing said source code to said binary for at least one discrepancy there-between; and
halting the deployment process if said at least one discrepancy is detected.
